(19) United States
(12) Patent Application Publication
(10) Pub. No.: US 2024/0378184 A1
(43) Pub. Date: Nov. 14, 2024

(54) INDEX RECOMMENDATION METHOD AND APPARATUS BASED ON DATA FEATURES

(71) Applicant: SHANGHAI KYLIGENCE INFORMATION TECHNOLOGY CO., LTD., Shanghai (CN)

(72) Inventors: Feng HUANG, Shanghai (CN); Pengfei ZHAN, Shanghai (CN); Yang LI, Shanghai (CN); Qing HAN, Shanghai (CN)

(73) Assignee: SHANGHAI KYLIGENCE INFORMATION TECHNOLOGY CO., LTD., Shanghai (CN)

(21) Appl. No.: 18/039,727

(22) PCT Filed: Dec. 12, 2022
(86) PCT No.: PCT/CN2022/138311

§ 371 Date: Jun. 1, 2023

(30) Foreign Application Priority Data
Jul. 18, 2022 (CN) 202210843501.0

(51) Int. Cl. G06F 16/22

(52) U.S. Cl. CPC G06F 16/2264

(57) ABSTRACT

An embodiment of the present invention discloses an index recommendation method and apparatus based on data features. The method includes following steps: acquiring multiple dimensions from query historical data of a user, and constructing an aggregation group according to the dimensions; creating initial indexes according to the aggregation group, which are divided into multiple levels according to dimension combinations; pre-screening the initial indexes of each level based on a sampling algorithm to obtain a candidate index set; and searching an index subset with the minimum cost value from the candidate index set through a genetic algorithm or a greedy algorithm to serve as a recommended index. The present invention can significantly improve the efficiency of pre-computation and save the storage and computation cost.

### TECHNICAL FIELD

The present invention relates to the technical field of data processing, and particularly relates to an index recommendation method and apparatus based on data features, a computer device and a storage medium.

### BACKGROUND

The idea of big data is deeply popular, and the demand for data analysis is also increasing day by day. For the continuously increasing data volume, pre-computation is obviously an extremely important technical direction in the field of online analysis (OLAP), which greatly reduces the time cost of data analysis through the idea of space for time, and effectively supports a low-delay and high-concurrency data analysis scene.

Apache Kylin is the representative of the specific implementation of the pre-computation technology in the OLAP field and can be fully used by a Cube system. During data analysis, any multiple dimensions can be set for the data, while the Cube is just like a multi-dimension group of the data. The process of loading the original data into the Cube is the pre-computation process of the Apache Kylin, and mainly includes association and summarization. Under the condition that no branch reduction optimization is adopted, the Apache Kylin will pre-compute the combination of each dimension, and the computation result of each dimension combination is called Cuboid, which, in a larger sense, is also an index and forms the Cube. With the increase of the number of dimensions, the number of indexes is increased in an exponential order, so that great cost is brought to the computation and storage end, and the actual availability of the pre-computation technology is reduced. At present, most of the solutions to this problem are to reduce the branches of the Cube through some fixed screening rules, such as necessary dimensions, hierarchical dimensions and joint dimensions, to achieve the purpose of reducing the number of indexes. This solution requires data analysts to deeply master the multi-dimension analysis theory and the service scene. However, in the cold start process of a system, it is almost impossible to set a reasonable screening strategy without the experience in data analysis. On the other hand, the data in a real scene is continuously changed, and thus it is difficult to timely dynamically adjust the screening strategy.

In view of the problem of low automation efficiency of a current index screening solution in related technology, no effective solution has been proposed at present.

### SUMMARY

An embodiment of the present invention provides an index recommendation method and apparatus, a computer device and a storage medium based on data features, aiming at solving the problem of low automation efficiency of a current index screening solution in related technology.

In order to achieve the purpose above, in a first aspect, the embodiment of the present invention provides an index recommendation method based on data features, includes:
acquiring multiple dimensions from a user's query historical data, and constructing an aggregation group according to the dimensions;
creating initial indexes according to the aggregation group, which are divided into multiple levels according to dimension combinations;
pre-screening the initial indexes of each level based on a sampling algorithm to obtain a candidate index set; and
searching an index subset with the minimum cost value from the candidate index set through a genetic algorithm or a greedy algorithm to serve as a recommended index.
alternatively, a possible embodiment in the first aspect, after obtaining the candidate index set, includes:
performing data feature extraction on all the indexes in the candidate index set, including column types cited by the indexes, cardinal numbers and row average sizes;
computing the cardinal number of each dimension in the candidate index set and the cardinal number of each index through an inexact HyperLogLog algorithm; and
estimating the row average size of each index in the candidate index set through the sampling algorithm.
alternatively, in a possible embodiment in the first aspect, the initial indexes of each level are pre-screened based on a sampling algorithm to obtain a candidate index set, includes:
computing a cosine distance between every two of all initial indexes of each level, where all the initial indexes not including single-dimension indexes and full-dimension indexes; and
treating the initial indexes as candidate indexes in a case that the cosine distance is smaller than a preset threshold value.
alternatively, in a possible embodiment in the first aspect, an index subset with the minimum cost value is searched out from the candidate index set through a genetic algorithm or a greedy algorithm to serve as a recommended index, includes:
optimizing the candidate index set according to a cost function to obtain the index subset, which is shown as follows:

f(x)=αg(x)+βh(x)
wherein g(x) represents the storage cost of the indexes and is determined by the cardinal number of the indexes and the row average size, h (x) represents the query cost caused by index missing, and α and β respectively represent cost coefficients.

In a second aspect, an embodiment of the present invention provides an index recommendation apparatus based on data features, which includes:
an aggregation group construction module which is configured to acquire multiple dimensions from a user's query historical data, and constructing an aggregation group according to the dimensions;
an initial index construction module which is configured to create initial indexes according to the aggregation group, which are divided into multiple levels according to dimension combinations;
a candidate index set determination module which is configured to pre-screen the initial indexes of each level based on a sampling algorithm to obtain a candidate index set; and
a recommended index determination module which is configured to search an index subset with the minimum cost value from the candidate index set through a genetic algorithm or a greedy algorithm to serve as a recommended index.
alternatively, in a possible embodiment in the second aspect, the apparatus includes:
an index cardinal number determination module which is configured to compute the cardinal number of each dimension in the candidate index set and the cardinal number of each index through an inexact HyperLogLog algorithm; and
an index row average determination module which is configured to estimate the row average size of each index in the candidate index set through the sampling algorithm.
alternatively, in a possible embodiment in the second aspect, the candidate index set determination module includes:
a cosine distance computation unit which is configured to compute a cosine distance between every two of all initial indexes of each level, wherein all the initial indexes not including single-dimension indexes and full-dimension indexes; and
a candidate index determination unit which is configured to treat the initial indexes as candidate indexes in a case that the cosine distance is smaller than a preset threshold value.

In a third aspect, an embodiment of the present invention provides a computer device, which includes a memory and a processor, wherein a computer program which can be operated in the processor is memorized in the memory, and the processor is configured to implement the steps of the method embodiments above while executing the computer program.

In a fourth aspect, an embodiment of the present invention provides a readable storage medium for storing the computer program, and the steps of the method in the first aspect or the steps of various possibly designed methods in the present invention are implemented while the computer program is executed by the processor.

The index recommendation method and apparatus, the computer device and the storage medium based on the data features acquires the multiple dimensions from user's query historical data, and constructs the aggregation group according to the dimensions; creates the initial indexes according to the aggregation group, which are divided into multiple levels according to the dimension combinations; pre-screens the initial indexes of each level based on the sampling algorithm to obtain the candidate index set; and searches the index subset with the minimum cost value from the candidate index set through the genetic algorithm or the greedy algorithm to serve as the recommended index. The present invention can significantly improve the efficiency of pre-computation and save the storage and computation cost.

### BRIEF DESCRIPTION OF THE DRAWINGS

FIG. 1 is a flowchart of an index recommendation method based on data features provided by an embodiment of the present invention;

FIG. 2 is a schematic diagram of an initial index generated by a combination group;

FIG. 3 is a schematic diagram of other indexes containing D dimension except ABCD; and

FIG. 4 is a structure chart of an index recommendation apparatus based on data features provided by an embodiment of the present invention.

### DETAILED DESCRIPTION OF THE EMBODIMENTS

To make the purpose, technical solutions and advantages of the embodiments of the present invention clearer, the technical solutions in the embodiment of the present invention will be described clearly and completely in combination with the drawings in the embodiments of the present invention. And obviously, the described embodiments are only part of the embodiments of the present invention, not all of them. Based on the embodiments in the present invention, all other embodiments obtained by those of ordinary skill in the art without creative work shall fall within the protection scope of the present invention.

In the specification, claims, and the foregoing accompanying drawings of the present invention, the terms “first”, “second”, “third”, “fourth”, etc. (if any) are used for distinguishing similar objects, and are not necessarily used for describing a specific order or sequence. It is to be understood that data used in this way is exchangeable in a proper case, so that the embodiments of the present invention described herein can be implemented in an order different from the order shown or described herein.

It is to be understood that in various embodiments of the present invention, the sequence number of each process does not mean the sequence of execution. The execution sequence of each process should be determined by its function and internal logic, and should not constitute any restriction on the implementation process of the embodiments of the present invention.

In addition, the terms “including” and “having”, and any variations thereof, are intended to cover non-exclusive inclusion, for example, a process, method, system, product or device including a series of steps or units is not necessarily limited to those steps or units expressly listed, but may include steps or units not expressly listed or inherent to the process, method, product or device other steps or units.

It is to be understood that in the present invention, “multiple” refers to two or more “And/or” is only an association relationship that describes the associated object, indicating three kinds of relationships, for example, A and/or B, which can indicate that there is only A, there are A and B, and there is only B. The character “/” generally indicates that the associated object is an “or” relationship. “Including A, B and C”, “including A, B, C” means that A, B and C are all included; “including A, B or C” means that one of A, B and C is included; and “including A, B and/or C” means that any one or two or three of A, B and C are included.

It is to be understood that in the present invention, “B corresponding to A”, “A corresponds with B” or “B corresponds with A” means that B is related to A, and B can be determined according to A. Determining B according to A does not mean that B is determined only according to A, but also according to A and/or other information. The match between A and B means that the similarity between A and B is greater than or equal to the preset threshold.

Depending on the context, “if” as used herein can be interpreted as “while” or “when” or “in response to determination” or “in response to detection”.

The technical solution of the present invention is described in detail with specific embodiments as follows. The following embodiments may be mutually combined, and same or similar ideas or processes may not be repeatedly described in some embodiments.

### Embodiment 1

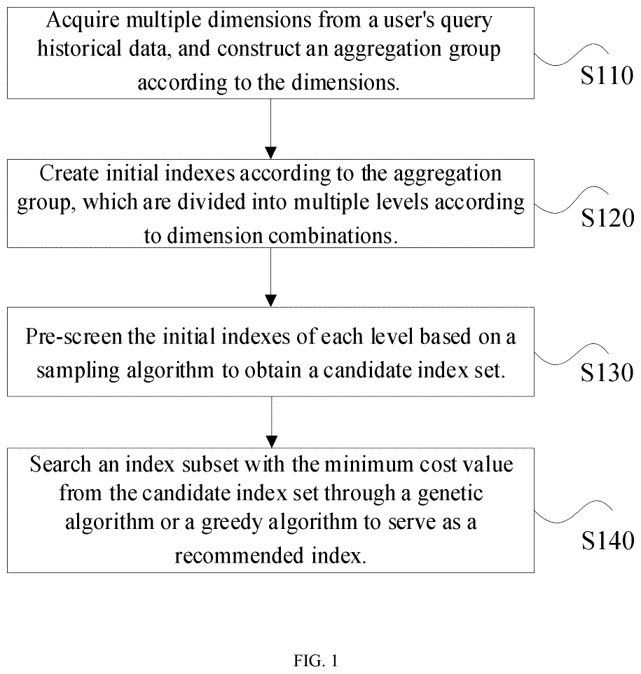

The present invention provides an index recommendation method based on data features, whose flowchart is shown in FIG. 1. The method includes the following steps:

Step S110: Acquire multiple dimensions from a user's query historical data, and construct an aggregation group according to the dimensions.

In this step, relevant dimension information can be extracted from the user's query history, and the aggregation group is constructed according to the extracted dimension information, so that the initial indexes can be created by using the aggregation group subsequently. Examples are used for illustrating: dimensions A, B, C and D are obtained by sorting the user's query history data, and then aggregation group is created according to these dimensions, including the dimensions ABCD.

S120: Create initial indexes according to the aggregation group, which are divided into multiple levels according to dimension combinations.

In the step S120, the abovementioned examples are continuously used for illustrating;

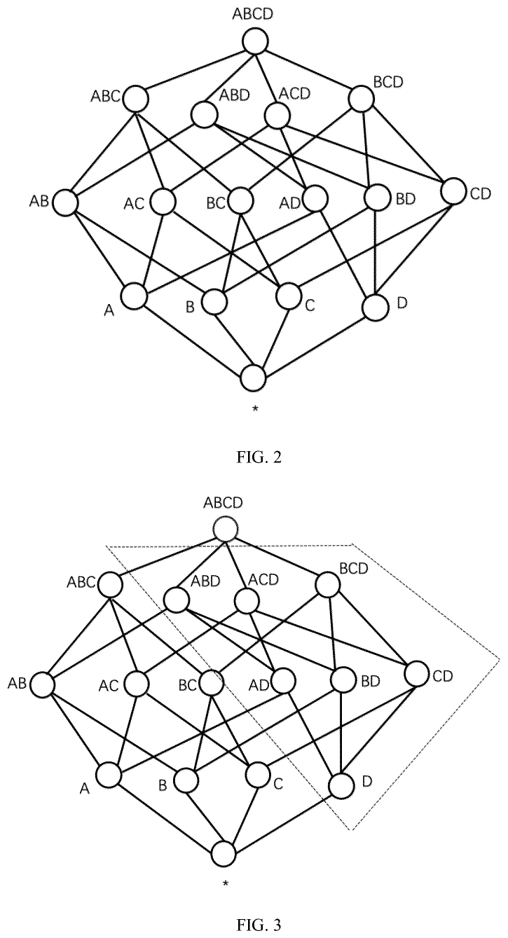

the aggregation group includes the dimensions A, B, C and D, and the initial indexes generated by one aggregation group are as shown in FIG. 2 (except *) and are divided into four levels according to the dimension combinations, namely, [A, B, C, D], [AB, AC, AD, BC, BD, CD], [ABC, ABD, ACD, BCD], [ABCD]. According to the present invention, the index construction is to evaluate the comprehensive value of each index according to the storage cost and the query cost of the index. The constructed index is used for service query, so the storage cost of the index can be considered from the perspective of query: 1) the query range covered by the index, and 2) the query time consumption acceleration ratio.

Specifically, the query range covered by the index can be the number of queries which can be answered by the constructed index, and the query time consumption acceleration ratio is the time consumption ratio of index query to non-index query. For example, if an aggregation index “Index 1” includes dimensions A, B and C and measurements M1, M2 and M3, from the perspective of query range, as long as a query statement queries any index of the abovementioned dimension and measurement combination, it can be covered by the index. In this example, if the time consumption for hitting the index is t1, the time consumption for not hitting the index is t2, the acceleration ratio is (t2−t1)/t2; and if t1>t2, negative acceleration is performed, namely, the speed is lower than that under the condition that the index is not hit.

S130: Pre-screen the initial indexes of each level based on a sampling algorithm to obtain a candidate index set.

In this step, after the initial indexes are created according to the aggregation group, because of the problem that too many dimensions may cause dimension explosions when the indexes are generated, the initial indexes of all the levels will be pre-screened according to a stratified sampling algorithm during searching so as to obtain a small index set. In the pre-screening process, the cosine distance between every two initial indexes of each level will be computed (all the initial indexes do not include single-dimension indexes and full-dimension indexes); and if the cosine distance is smaller than a preset threshold value, the initial indexes serve as candidate indexes. The smaller the cosine distance is, the more dissimilar the two indexes are, and in order to put the indexes with the small similarity into the candidate set as much as possible, the preset threshold value is set (the threshold value can be manually set according to the actual condition). In this way, the total number of the indexes reserved finally does not exceed 2n², the total number of the original indexes is 2ⁿ; and if n is very large, 2n² is far smaller than 2ⁿ. The indexes obtained through the steps above can serve as one initial candidate set.

S140: Search an index subset with the minimum cost value from the candidate index set through a genetic algorithm or a greedy algorithm to serve as a recommended index.

In the step S140, after all levels are pre-screened to obtain the candidate index set, the subset with the minimum cost value can be obtained by searching based on the genetic algorithm or the greedy algorithm. The subset is obtained by continuously optimizing the candidate index set according to the cost function, and the definition of the cost function is shown as follows:

$$f ( x ) = α g ( x ) + β h ( x )$$

wherein g(x) represents the storage cost of the indexes and is determined by the cardinal number of the indexes and the row average size, h(x) represents the query cost caused by index missing, and α and β respectively represent cost coefficients.

Specifically, the storage cost of the index can be the number of bytes occupied by the estimated index, and the query cost of the index can be the time consumed for constructing the index. The cardinal number and the row average size of the index belong to the data features of the index and can be obtained by an inexact HyperLogLog (HLL) method and the sampling algorithm.

More specifically, the “continuously optimizing the candidate index set according to the cost function” is substantially to optimize the candidate index set according to the storage cost and the query cost of the indexes, which is illustrated by examples as follows: it is assumed that the defined cost of obtaining the index D is estimated to be 100, and the defined cost of the indexes ABCD is 110, obviously, the two costs are very close; when the ABCD are reserved, the index with the D dimension can be absolutely covered; but if only the index with the D dimension is reserved, the dimensions ABCD cannot be inquired at the same time, thus the inquiry cost is very high, and finally the ABCD will be reserved. Therefore, compared with using ABCD indexes alone, the storage cost of other indexes containing the D dimension (as shown in the box in FIG. 3) is larger than the query income it brings, and these indexes will be excluded from the optimal indexes. Whether the remaining indexes are needed or not depends on the balance of the query cost and storage cost of the remaining indexes, and the indexes will be optimized by continuous iteration. In conclusion, an algorithm for automatically screening according to the data features in a mode of modeling through index cost under the condition of no service knowledge is realized. In addition, in the actual use process, whether data is changed or not can be detected at a certain frequency; and if the data is changed, a new index will be recommended according to the method above, so that the problem of index performance reduction caused by data change is prevented.

In one embodiment, after obtaining the candidate index set, it includes:
performing data feature extraction on all the indexes in the candidate index set, including column types cited by the indexes, cardinal numbers and row average sizes;
computing the cardinal number of each dimension in the candidate index set and the cardinal number of each index through an inexact HyperLogLog algorithm; and
estimating the row average size of each index in the candidate index set through the sampling algorithm.

In this embodiment, after the candidate index set is obtained by pre-screening the indexes of all levels, all the indexes in the candidate index set need to be sampled to determine the cardinal numbers of the indexes, that is, the cardinal numbers of the four dimensions A, B, C and D are estimated through the inexact HyperLogLog (HLL) algorithm; then, a set with a small data size is obtained for the indexes of each level through the sampling algorithm; and the sample cardinal numbers of A, B, C and D and the cardinal number of each index are computed based on the set, and the estimated cardinal numbers of the indexes are derived. In order to control the sampling frequency, data sampling can be executed on each level once, and sampling frequency depends on the number of the dimensions. Except for the single-dimension index [A, B, C, D] and the full-dimension index [ABCD], the number of the other levels is controlled to be within two times of the total number of the dimensions. Similarly, the row average size of each index can be estimated from the candidate index set through the sampling algorithm in this step.

According to the present invention, the index recommendation method based on the data features includes the following steps: acquiring the multiple dimensions from the user's query historical data, and constructing the aggregation group according to the dimensions; creating the initial indexes according to the aggregation group, which are divided into multiple levels according to dimension combinations; pre-screening the initial indexes of each level based on the sampling algorithm to obtain the candidate index set; and searching the index subset with the minimum cost value from the candidate index set through the genetic algorithm or the greedy algorithm to serve as the recommended index. The present invention can significantly improve the efficiency of pre-computation and save the storage and computation cost.

Technical effects:
(1) According to the present invention, recommendation is carried out according to the original data features, and other input is not needed, so that index recommendation can be automatically completed. No service knowledge is required, which reduces the entry threshold of the precomputing system in the cold start process.
(2) According to the present invention, the initial indexes of all the levels will be pre-screened according to the stratified sampling algorithm during searching so as to obtain the small index set, thus effectively solving the problem that too many dimensions may cause dimension explosions.
(3) According to the present invention, the idea of carrying out index recommendation through the data features is adopted, thus the limitation of service input is avoided, and automatic and rapid analysis of data can be realized.

### Embodiment 2

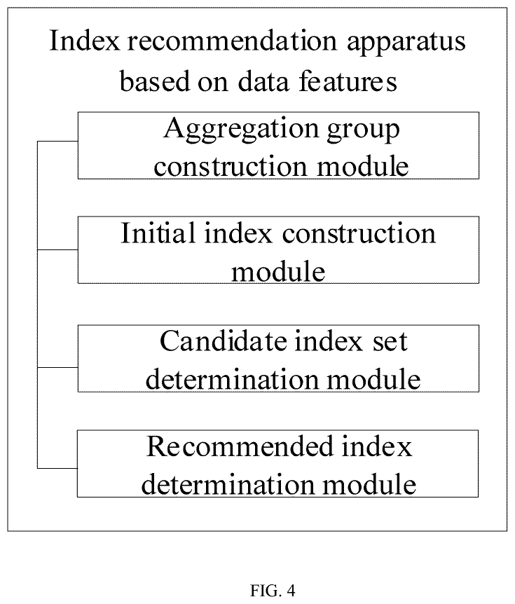

An embodiment of the present invention further provides an index recommendation apparatus based on data features, as shown in FIG. 4, includes:
an aggregation group construction module which is configured to acquire multiple dimensions from a user's query historical data, and constructing an aggregation group according to the dimensions;
an initial index construction module which is configured to create initial indexes according to the aggregation group, which are divided into multiple levels according to dimension combinations;
a candidate index set determination module which is configured to pre-screen the initial indexes of each level based on a sampling algorithm to obtain a candidate index set; and
a recommended index determination module which is configured to search an index subset with the minimum cost value from the candidate index set through a genetic algorithm or a greedy algorithm to serve as a recommended index.

In one example, the apparatus further includes:
an index cardinal number determination module which is configured to compute the cardinal number of each dimension in the candidate index set and the cardinal number of each index through an inexact HyperLogLog algorithm; and
an index row average determination module which is configured to estimate the row average size of each index in the candidate index set through the sampling algorithm.

In one embodiment, the candidate index set determination module includes:
a cosine distance computation unit which is configured to compute a cosine distance between every two of all initial indexes of each level, wherein all the initial indexes not including single-dimension indexes and full-dimension indexes; and
a candidate index determination unit which is configured to treat the initial indexes as candidate indexes in a case that the cosine distance is smaller than a preset threshold value.

### Embodiment 3

An embodiment of the present invention further provides an index recommendation algorithm based on data features. When an OLAP engine is used for performing pre-computation, indexes to be pre-computed can be automatically selected according to the data features based on the algorithm, and thus the storage cost and the computation cost of pre-computation can be reduced.

The algorithm includes the following three parts: index cost modeling, data feature collection and optimal index searching. Then, the three parts are introduced in detail as follows.

The index cost modeling is to comprehensively evaluate the value brought by each index according to the storage cost and the computation cost of the index. The index storage cost is the number of bytes occupied by the estimated index, and the computation cost of the index is the time consumed for constructing the index. The constructed index is used for service query, so the storage cost of the index can be considered from the perspective of query: 1) the query range covered by the index, and 2) the query time consumption acceleration ratio. The query range covered by the index can be the number of queries which can be answered by the constructed index, and the query time consumption acceleration ratio is the time consumption ratio of index query to non-index query. For example, if an aggregation index “Index 1” includes dimensions A, B and C and measurements M1, M2 and M3, from the perspective of query range, as long as a query statement queries any index of the abovementioned dimension and measurement combination, it can be covered by the index. In this example, if the time consumption for hitting the index is t1, the time consumption for not hitting the index is t2, the acceleration ratio is (t2−t1)/t2; and if t1>t2, negative acceleration is performed, namely, the speed is lower than that under the condition that the index is not hit.

The data feature collection is to collect data statistical information including the column type and the cardinal number which are introduced by the index, the average size of a row of data, etc. In many big data systems, the original data size may be large, so the inexact HyperLogLog (HLL) method may be used for estimation, and the row average size of the data will be estimated through some sampling methods.

Optimal index search is to search an optimal index set, and is carried out by the following steps:
firstly, related dimension information is extracted based on the query history of the user;
secondly, initial indexes are created based on the aggregation group, and the initial indexes of all the levels are pre-screened according to the stratified sampling algorithm during searching so as to obtain a small index set, thus solving the problem that too many dimensions may cause dimension explosions when the indexes are generated; and
finally, an index subset with the minimum cost value is searched from the small index set by a cost model through a genetic algorithm or a greedy algorithm to serve as a final recommended index.

The idea of modeling the index cost in this application focuses on evaluating the storage cost of the index and the query benefits it brings.

The readable storage medium can be a computer storage medium or a communication medium. The communication medium includes any medium convenient for transmitting the computer program from one place to another place. The storage medium can be any available medium which can be accessed by a general purpose or special purpose computer. For example, the readable storage medium is coupled to the processor, so that the processor can read information from the readable storage medium and write the information into the readable storage medium. Certainly, the readable storage medium can also be a component of the processor. Processors and the readable storage medium can be positioned in an Application Specific Integrated Circuits (ASIC). In addition, the ASIC can be located in user equipment. Of course, the processors and the readable storage medium can also serve as discrete components in communication equipment. The readable storage medium can be a read-only memory (ROM), a random access memory (RAM), a CD-ROM, a magnetic tape, a floppy disk, optical data storage equipment and the like.

The present invention further provides a program product. The program product includes an execution instruction which is stored in the readable storage medium. At least one processor of the equipment can read the execution instruction from the readable storage medium, and the at least one processor executes the execution instruction to enable the equipment to implement the methods provided by the abovementioned various embodiments.

In the abovementioned embodiments of the terminal or server, it is to be understood that the processor may be Central Processing Unit (CPU), or other universal processors, Digital Signal Processor (DSP), etc. The general processor can be a microprocessor or any conventional processor and the like. The steps of the method disclosed by the embodiment of the present invention can be directly executed by a hardware decoding processor or executed by the combination of hardware and software modules in the decoding processor.

Finally, it is to be noted that the above embodiments are only used to illustrate the technical solution of the present invention, not to limit it; Although the present invention has been described in detail with reference to the preceding embodiments, ordinary technical personnel in the art should understand that they can still modify the technical solutions recorded in the preceding embodiments, or replace some or all of the technical features equally; However, these modifications or replacements do not make the essence of the corresponding technical solutions separate from the scope of the technical solutions of the embodiments of the present invention.

1. An index recommendation method based on data features, comprising:
acquiring multiple dimensions from a user's query historical data, and constructing an aggregation group according to the dimensions;
creating initial indexes according to the aggregation group, which are divided into multiple levels according to dimension combinations;
pre-screening the initial indexes of each level based on a sampling algorithm to obtain a candidate index set; and
searching an index subset with the minimum cost value from the candidate index set through a genetic algorithm or a greedy algorithm to serve as a recommended index.

2. The index recommendation method based on the data features according to claim 1, wherein after obtaining the candidate index set, comprises:
performing data feature extraction on all the indexes in the candidate index set, comprising column types cited by the indexes, cardinal numbers and row average sizes;
computing the cardinal number of each dimension in the candidate index set and the cardinal number of each index through an inexact HyperLogLog algorithm; and
estimating the row average size of each index in the candidate index set through the sampling algorithm.

3. The index recommendation method based on the data features according to claim 1, wherein the pre-screening the initial indexes of each level based on a sampling algorithm to obtain a candidate index set, comprises:
computing a cosine distance between every two of all initial indexes of each level, where all the initial indexes not comprising single-dimension indexes and full-dimension indexes; and
treating the initial indexes as candidate indexes in a case that the cosine distance is smaller than a preset threshold value.

4. The index recommendation method based on the data features according to claim 2, wherein the searching an index subset with the minimum cost value from the candidate index set through a genetic algorithm or a greedy algorithm to serve as a recommended index, comprises:
optimizing the candidate index set according to a cost function to obtain the index subset, which is shown as follows:
$$f ( x ) = α g ( x ) + β h ( x )$$
wherein g(x) represents the storage cost of the indexes and is determined by the cardinal number of the indexes and the row average size, h (x) represents the query cost caused by index missing, and α and β respectively represent cost coefficients.

5. An index recommendation apparatus based on data features, comprising:
an aggregation group construction module which is configured to acquire multiple dimensions from a user's query historical data, and constructing an aggregation group according to the dimensions;
an initial index construction module which is configured to create initial indexes according to the aggregation group, which are divided into multiple levels according to dimension combinations;
a candidate index set determination module which is configured to pre-screen the initial indexes of each level based on a sampling algorithm to obtain a candidate index set; and
a recommended index determination module which is configured to search an index subset with the minimum cost value from the candidate index set through a genetic algorithm or a greedy algorithm to serve as a recommended index.

6. The index recommendation apparatus based on the data features according to claim 5, comprises:
an index cardinal number determination module which is configured to compute the cardinal number of each dimension in the candidate index set and the cardinal number of each index through an inexact HyperLogLog algorithm; and
an index row average determination module which is configured to estimate the row average size of each index in the candidate index set through the sampling algorithm.

7. The index recommendation apparatus based on the data features according to claim 5, wherein the candidate index set determination module comprises:
a cosine distance computation unit which is configured to compute a cosine distance between every two of all initial indexes of each level, wherein all the initial indexes not comprising single-dimension indexes and full-dimension indexes; and
a candidate index determination unit which is configured to treat the initial indexes as candidate indexes in a case that the cosine distance is smaller than a preset threshold value.

8. A computer device, comprising a memory and a processor, wherein a computer program which can be operated in the processor is memorized in the memory; and the processor is configured to implement the steps of the method according to any one of claims 1 to 4 while executing the computer program.

9. A computer readable storage medium for storing the computer program, wherein the steps of the method according to any one of claims 1 to 4 are implemented while the computer program is executed by the processor.
